(19) United States
(12) Patent Application Publication
(10) Pub. No.: US 2016/0207674 A1
(43) Pub. Date: Jul. 21, 2016

(54) PACKAGING STRUCTURE FOR THE STORAGE AND DISTRIBUTION OF A BULK PRODUCT

(71) Applicants: ARDAGH MP GROUP NETHERLANDS B.V., Deventer (NL); ARDAGH MP WEST FRANCE, Paris (FR)

(72) Inventor: Alexandre BRION, Paris (FR)

(21) Appl. No.: 14/904,338

(22) PCT Filed: Jul. 9, 2014
(86) PCT No.: PCT/FR2014/051759

§ 371 Date: Jan. 11, 2016

(30) Foreign Application Priority Data
Jul. 9, 2013 (FR) 1356746

(51) Int. Cl. B65D 51/24; G01F 19/00; B65D 53/02; B65D 43/02; B65D 51/18

(52) U.S. Cl. CPC B65D 51/246; B65D 43/02; B65D 51/18; B65D 53/02; G01F 19/002; B65D 2251/0018; B65D 2251/0028; B65D 2251/009

(57) ABSTRACT

A packaging structure (1) for the storage and distribution of a bulk product, for example a powder product, includes: a metal container (2) in the form of a box, including (i) a container body (3), the upper part (5) of which defines an upper opening (6), and (ii) a cover structure (7), with a metal mounting ring (8) and a peelable membrane (9) for closing the upper opening (6); an accessory (11) for removing and distributing a portion of the packaged product; and elements (14, 5) for detachably mounting the accessory (11) on the metal mounting ring (8).

### TECHNICAL FIELD TO WHICH RELATES THE INVENTION

The present invention relates to the general field of packaging. It more particularly relates to a packaging structure for the storage and the distribution of a bulk product, for example a powder product such as baby milk powder or powdered coffee.

### TECHNOLOGICAL BACK-GROUND

Some products, in particular the pulverulent products such as baby powder milk, for example, are packaged in metal boxes formed of a cylindrical metal body whose lower part is provided with a bottom structure, and whose upper part includes an opening sealed by a lid structure.

As shown in the documents EP-0 408 268, EP-1 595 808 or EP-1 878 666, conventionally, this lid structure comprises a metal mounting ring, associated with a central sealing member in the form of a peelable membrane, or of a one piece obturator delimited by a score line.

In some cases, an overcap made of plastic material may cover the unit in a removable manner.

The external part of the mounting ring is fixed to the edge that delimits the upper opening of the cylindrical box body, for example by seaming. Its internal part includes a planar annular flange, the internal edge of which delimits an opening for the access to the packaged product, on top of which is fixed the peelable membrane, or in the continuation of which extends the one piece obturator.

The peelable membrane is provided with an integral pull tab, or the one piece obturator is provided with an added pull ring, to allow their detachment from the annular flange, at the time of the first opening of the box, by a simple pulling action.

This annular flange may, in some cases, be continued towards the inside by a one piece plate in the shape of a disk portion, whose internal rectilinear edge delimits a part of the access opening to the packaged product.

The overcap serves, after the first opening of the packaging structure (i.e. after the peelable membrane or the one piece obturator has been removed), to releasably close off this access opening to the product.

In some cases, in particular when the packaged product is baby powder milk, this packaging structure also includes an accessory in the form of a measuring spoon, provided with a collection cup continued by a handle, to collect amounts of product.

At the time of packaging of the product, the accessory in the form of a measuring spoon is either introduced in the packaging volume, or associated with the metal box, outside this packaging volume, for example interposed between the central sealing member of the mounting ring and the overcap.

After the package has been open, this accessory is used to collect the desired amounts of product; thereafter, it is put back in the packaging volume, and the overcap is put in place.

However, this collecting accessory is then not always of very easy access, especially when it is buried into the powder, or when it is placed at the bottom of the box due to the fact that it does not remain a lot of packaged product.

In the field of packaging made of plastic material, it is known from the documents FR-2 915 969 or GB-2 475 872, lid structures made of moulded plastic, which include means allowing the releasable assembly of the collection/distribution accessory. But these plastic structures are very different from the metal packages. In particular, they require the implementation of complex technical means to be made by moulding.

### OBJECT OF THE INVENTION

The present invention proposes an original metallic (or essentially metallic) packaging structure that allows to facilitate the accessibility to this collection accessory, in order to optimise the use thereof.

The packaging structure according to the invention, for the storage and the distribution of a bulk product, for example a powder product, is hence of the type comprising:
a container in the form of a box, which container includes (i) a metal container body provided with a lower part and an upper part, which upper part delimits an upper opening, and (ii) a lid structure, to seal said upper opening, said lid structure comprises:
   (i) a metal mounting ring including—an external part adapted to be fixed to an edge of said container body delimiting said upper opening, and—an internal part provided with an annular flange, intended to extend at said body opening, said internal part including an internal edge delimiting an access opening to the packaged product,
   (ii) a sealing member for said access opening to the packaged product, consisting in a peelable membrane hermetically fixed, in a detachable manner, to said annular flange, and
   (iii) a removable overcap, intended to be positioned on the upper edge of the container body, above said mounting ring and its associated sealing member, to seal said access opening to the packaged product, and
an accessory for the collection and the distribution of a portion of said packaged product.
   And, according to the present invention, this packaging structure is characterized in that it includes means for making a releasable assembly of said accessory with said metal mounting ring.

According to a preferred embodiment, the annular flange of the mounting ring is continued towards the inside by a plate, which plate is in the shape of a disk segment, provided with an internal edge that delimits a part of said access opening to the packaged product, and which plate extends in the plan or substantially in the plan of said annular flange.

The accessory for the collection and the distribution of a portion of the packaged product advantageously includes a handle at one end of which is arranged a functional structural part for the collection and the distribution of the product.

According to a preferred embodiment, this accessory consists in a measuring spoon, provided with a cup-shaped functional structural part.

According to a particular embodiment, said releasable assembly means include at least one orifice formed in said mounting ring, said orifice being adapted to receive the functional structural part or the handle of said accessory.

Within this framework, said orifice(s) may be made in the plate that continues the annular flange of the mounting ring; then, this plate may include an orifice, of closed contour or emerging in its internal edge, adapted to receive, by embedding, the cup-shaped functional structural part of said accessory; in an alternative embodiment, this plate may include at least one orifice adapted to receive the handle of said accessory.
The corresponding orifice goes through the plate, with its axis extending perpendicular or substantially perpendicular to the plan of said plate; in an alternative embodiment, this orifice is made in or by a cut and/or folded part of the plate, in a manner adapted so that its axis extends parallel or substantially parallel to the plan of this plate.

In a particular embodiment, the plate includes a back-standing planar area on the side of the lower part of the container body and emerging in the internal edge thereof, back-standing planar area in which are formed said orifice(s).

For some of the above-mentioned embodiments, the collection and distribution accessory includes a hanging structure arranged so as to allow the hanging thereof to at least one orifice formed in said lid structure, for the releasable assembly thereof.

This hanging structure is then advantageously made at the free end of the accessory handle, located opposite the functional structural part thereof.

According to still another variant, the accessory includes a hanging structure arranged so as to allow the hanging thereof on the internal edge delimiting said access opening to the packaged product.

Then, this hanging structure is advantageously arranged so as to allow the hanging of the accessory on the internal edge of the plate that continues the annular flange of the mounting ring.
Within this framework, said hanging structure is preferably in the form of two arms delimiting between each other an engagement notch on said internal edge delimiting said access opening to the packaged product.

### DETAILED DESCRIPTION OF AN EXEMPLARY EMBODIMENT

The invention will be further illustrated, without being limited in any way, by the following description of several possible embodiments, given only by way of example, in relation with the appended drawings in which:

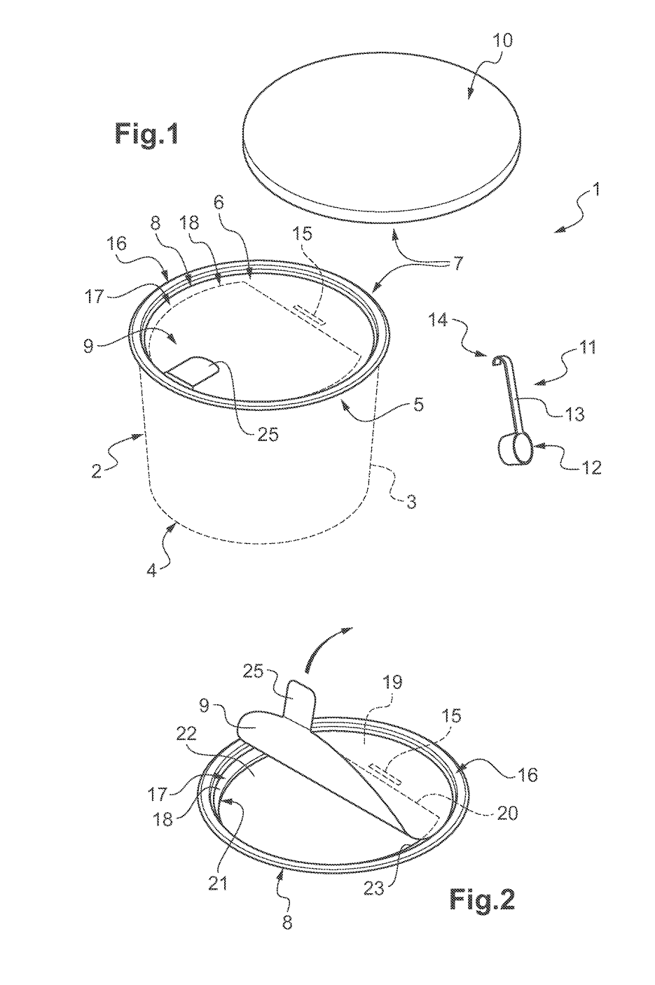

FIG. 1 is a schematic and perspective general view of a first embodiment of a packaging structure according to the invention, consisted of a container in the form of a box, whose lid structure comprises a mounting ring with a sealing member in the form of a peelable membrane, associated with an overcap, and provided with an accessory for the collection/distribution of the packaged product including a hanging structure;

FIG. 2 is a perspective view of the mounting ring of the lid structure of the packaging illustrated in FIG. 1, in which the peelable membrane is being peeled, at the time of the first opening;

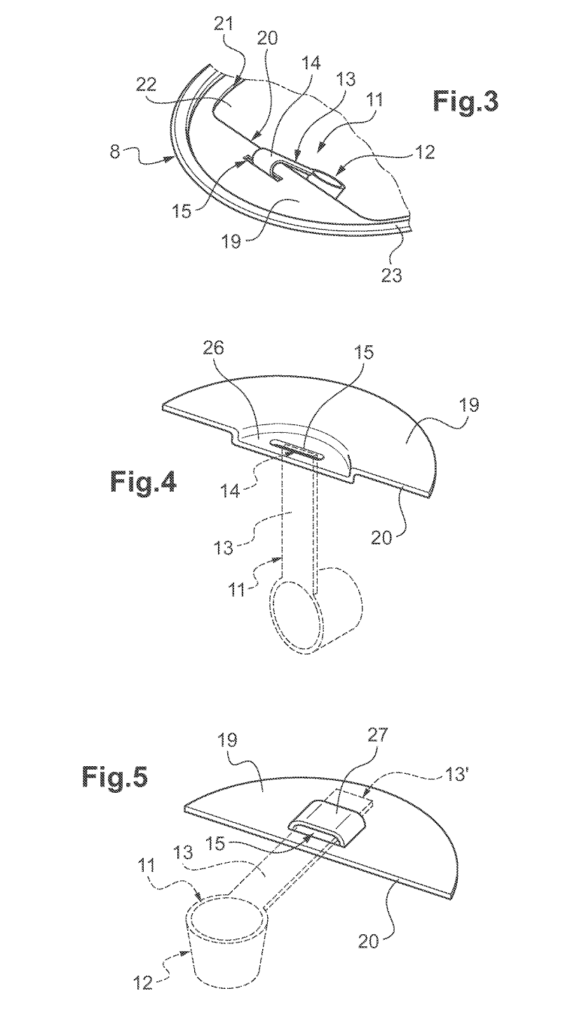

FIG. 3 is a partial perspective view, illustrating the collection/distribution accessory hanged to the receiving orifice of the mounting ring of the packaging structure of FIGS. 1 and 2, so as to facilitate the accessibility thereto;

FIG. 4 is a partial schematic view, that illustrates a possible alternative embodiment of the accessory hanging means;

FIG. 5 is a partial schematic view, that illustrates another possibility of structure of the accessory hanging means;

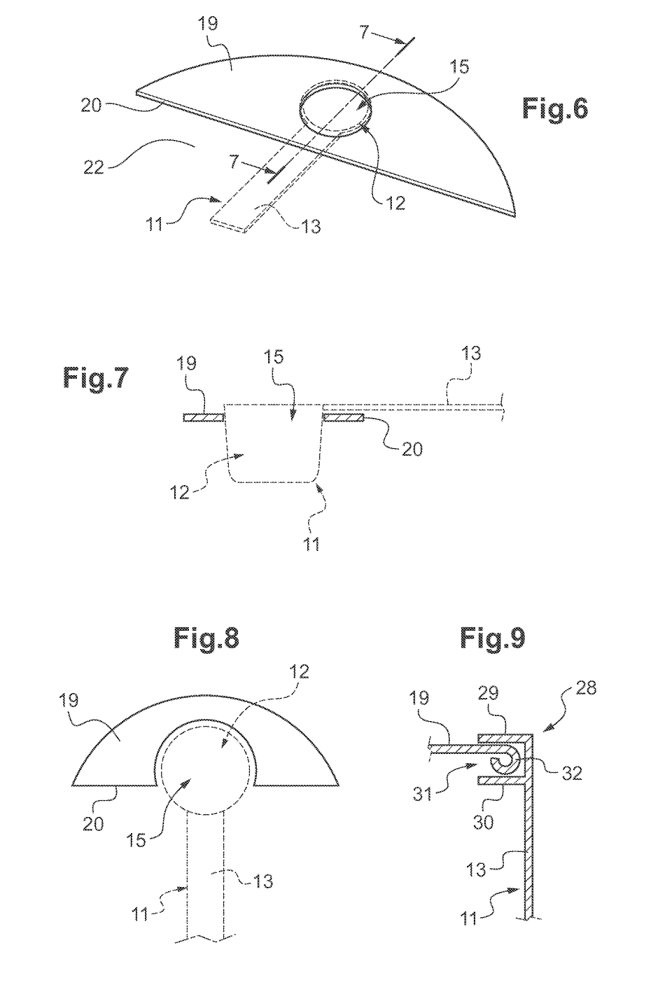

FIG. 6 is still a partial schematic view, that illustrates another possibility of structure of the accessory hanging means;

FIG. 7 is a sectional view according to the section plan 7-7 of FIG. 6;

FIG. 8 illustrates an alternative to the embodiment illustrated in FIGS. 6 and 7, viewed from above;

FIG. 9 is still a partial, sectional view, that illustrates another possibility of structure of the accessory hanging means.

The packaging structure 1 according to the invention, as shown in FIG. 1, is particularly adapted for the packaging of a powder product, for example milk powder or powdered coffee, but it could be used for the packaging of any other bulk product, even liquid or semi-liquid.

This packaging structure 1 includes for that purpose a container 2 in the form of a box, comprising a tubular body 3, advantageously made of metal (simply schematized in dotted line in FIG. 1), whose lower part 4 is sealed by a bottom structure (integral or added), not shown, and whose upper part 5 delimits an upper opening 6 sealed by a lid structure 7.

This container body 3 includes a lateral wall that may be of various configurations, dimensions and cross-sections.

The lid structure 7 is in particular adapted to be added on a container body 3 of circular cross-section. This lid structure 7 could also be adapted to be mounted on a body having another shape/cross-section: oval, square, rectangular, oblong, etc.; its general shape would then be adapted accordingly.

The constitutive material of this container body 3, and its manufacturing method, may be chosen by the one skilled in the art.

For example, the container body is made of metal, in particular steel or aluminium, chosen according to the product to be packaged.

Likewise, the constituent material of the bottom structure 4 and its manufacturing method, as well as the mounting thereof on the container body 3, may be chosen by the one skilled in the art.

The lid structure 7 is herein formed of—a mounting ring 8 associated with a peelable membrane 9 and—an overcap 10.

Moreover, the packaging structure 1 still includes an accessory 11 for the collection and the distribution of portions of the packaged powder product, which is herein in the form of a measuring spoon, for example made of plastic material; and means are provided for the releasable assembly of the accessory 11 with the lid structure 7, herein in the form of at least one orifice formed on the mounting ring 8 to allow the hanging of said collection/distribution accessory 11, the latter comprising for that purpose an adapted hooking structure.

Herein, the collection/distribution spoon 11 is consisted of a cup-shaped functional structural part 12 continued by a handle 13, whose free end includes a return in the form of a hooking structure 14 (also called in particular “hanging structure”); and this hooking structure 14 is adapted to be hung on/in an orifice 15 herein formed in the mounting ring 8, as described in detail hereinafter.

The hooking structure 14 has herein, for example, a general U-shape that is open towards the cup 12.

The lid structure 7 is adapted to be added at the upper end 5 of the container body 3.

It includes, as also illustrated in FIG. 2,—the mounting ring 8, fixed on the upper edge of the body 3 that delimits the upper opening 6 by any suitable technique, for example by seaming, associated with the peelable membrane 9, and—the overcap 10.

The mounting ring 8 advantageously consists in a metal part, for example made of steel or aluminium.

The shape and size of this ring 8 are adapted as a function of the cross-section of the container body 3 on which it is mounted.
Herein, this ring 8 has an annular or circular general shape.

As shown in particular in FIG. 2 (wherein the membrane 9 is being peeled), the ring 8 comprises:
an external peripheral annular part 16, adapted to be mechanically fastened to the free edge of the container body 3, for example by seaming, and
an internal part 17, intended to extend up to the opening 6 of the container body 3.

The internal part 17 is herein composed of a planar annular flange 18 provided, on a part of its periphery, with a plate 19 in the shape of a disk segment, extending up to a rectilinear internal edge 20.

The internal edge 20 has a thickness that herein corresponds to the thickness of the plate 19; in general, this edge 20 consists in a rolled-in free edge, in particular to prevent the user from cutting himself when handling this packaging structure 1, hence giving a greater thickness to this edge 20.

This internal part 17 is delimited by an internal edge 21, defining a central opening 22 allowing the access to the packaged product; this internal edge 21 is herein composed, for one part, of the internal edge 20 of the plate 19 and, for another part, of the free internal edge 23, in the form of a portion of circle, of the annular flange 18.

The plate 19 herein consists in a planar element, in the general shape of a disk segment, made integral with the ring 8. It extends in the plan of the annular flange 18. The central opening 22, for access to the packaged product, has herein a general shape of a partially truncated disk.

The internal free edge 20 of the plate 19 may be used to level the amount of product collected in the cup 12 of the measuring spoon 11.

The orifice 15 adapted to allow the hanging of the spoon 11, by its hanging structure 14, is made near the internal free edge 20 of the plate 19.

The through-axis of this orifice 15 extends perpendicular to the plan of the plate 19.

This orifice 15 has an elongated shape, herein of rectangular or substantially rectangular cross-section, whose great axis extends parallel to said internal edge 20, advantageously centred on the latter.

But any other shape and/or position of this orifice 15 may be contemplated.

The length and width of the orifice 15 are slightly higher than the width and thickness of the hooking structure 14 of the accessory 11, to optimise the hanging characteristics thereof.

The peelable membrane 9, shown in FIGS. 1 and 2, is for example of the type of that described in the document EP-1 878 666.

This peelable membrane 9, also called “operculum”, is hermetically fixed to the ring 8, advantageously through a link of the bonding/welding type (for example, a thermowelding technique). It covers the plate 19 with the orifice 15 thereof, and the central opening 22.

This membrane 9 is herein fastened, at its external peripheral edge, to the upper face of the annular flange 18 of the ring 8.

At its peripheral edge, the peelable membrane 9 also includes a tab 25, folded opposite and against its upper face (FIG. 1). According to other embodiments, this membrane 9 may be provided with several tabs 25 (at least two), suitably distributed. The function of this tab 25 is to facilitate the peeling of the membrane 3 by the user, with respect to the ring 8.

This tab 25 is advantageously made integral with the membrane 9, and consists in an extension of material.

As an alternative, the tab 25 may be added on the membrane 9, directly or indirectly (the membrane 9 is then obtained by the assembly of at least two parts).

The membrane 9 is herein added on the ring 8, so that its tab 25 extends diametrically opposed to the plate 19 and to the orifice 15.

For its part, the overcap 10 is advantageously made of a plastic material. It is adapted to cap the upper part of the container body 3 and in particular to fully cover the ring 8 and the access orifice 22 to the product, in a removable and preferably hermetic manner. Its structure of engagement on the top of the container body 3 is adapted accordingly.

In practice, the ring 8 and the peelable membrane 9 are made independently from each other by techniques known by the one skilled in the art, before being assembled for example by a thermowelding technique, on a first site of manufacturing.

The obtained unit 8-9 may be easily stored and transported to a packaging site, where it is mounted on the body of a container 3, after the filling thereof with the product.

The overcap is then engaged above this ring 8/membrane 9 unit.

The collection/distribution spoon 11 is placed in the packaging volume, with the packaged product (possibly packed in a small bag made of plastic material), or it is interposed between the membrane 9 and the overcap 10, if the available space is sufficient, or associated with the container body 3 by any other suitable means.

Once the packaging structure 1 open by removal of the overcap 10 and of the peelable membrane 9 (by means of a pulling action exerted on its tab 25), the packaged product is accessible and may be collected by means of the accessory spoon 11.

After the collection, the spoon 11 is hanged (or hooked) to the plate 19, through its hooking structure 14 and the hanging orifice 15 of said plate 19, as illustrated in FIG. 3, so as to facilitate its gripping, at the time of a latter use.

In particular, the hooking structure 14 covers the band of material extending between the hanging orifice 15 and the rectilinear internal edge 20.

The overcap 10 may then be suitably added, to seal the unit.

As an alternative, the sealing member for the access opening to the packaged product, associated with the mounting ring 8, may be consisted of an integral seal, equipped with a pull tab, continuing towards the inside the annular flange 18 and separated from the latter by a score line.

In this case, the orifice 15 for the hanging of the collection/distribution accessory 11 will be sealed by any removable means adapted to ensure the tightness of the packaging volume, before the first opening (for example, a removably-bound tight membrane).

It has been shown in FIGS. 4 to 8 alternative embodiments of the plate that continues the annular flange of the lid structure.

By way of simplification, only the plate in question has been shown in these figures, with the accessory 11 in the form of a measuring spoon, wherein the remaining of the packaging structure can correspond to the embodiment shown in FIGS. 1 to 3.

Moreover, to facilitate the understanding, the parts identical or similar to the embodiment of FIGS. 1 to 3 keep the same references.

In the embodiment shown in FIG. 4, the plate 19 includes a back-standing planar area 26, on the side of the lower part of the container body, and in which is formed the orifice 15.

This back-standing planar area 26 extends in an underlying plan parallel to the general plan of the plate 19, for example offset by a few millimetres.
It emerges in the internal edge 20 and may have a general shape of a disk portion.
The axis of the orifice 15 extends perpendicular to the plan of the area 26 and to the plan of the plate 19.
This back-standing planar area 26 may be obtained by embossing during the manufacturing of the mounting ring 8.
It allows the integration at least partial of the thickness of the hooking structure 14 of the accessory 11, to avoid the protrusion or the too significant protrusion of this hooking structure 14 above the plan of the plate 19, liable to hamper the putting in place of the overcap.

In an alternative embodiment, several orifices 15 may be formed in the back-standing area 26, and more generally on the plate 19.

Any shape of orifice 15 may be contemplated, as a function of the shape of the hooking structure 14.

In the embodiment illustrated in FIG. 5, the orifice 15 is made by means of a part of material 27 cut and folded from the plate 19.

This part of material 27 forms a kind of protruding tab or bridge defining an orifice 15 whose axis extends parallel or substantially parallel to the plan of the plate 19.
The cross-section of the orifice 15 is adapted to allow the insertion and the holding of the free end 13′ of the handle 13 of the accessory 11, as shown in FIG. 5.
Herein, the free end 13′ of the handle 13, located opposite the cup-shaped functional structural part 12, is straight, devoid of hooking structure.
The handle 13 of the accessory 11 then extends parallel to the plan of the plate 19; it is held by a slight clamping within the orifice 15 and may be very easily removed and put back in place (by a translation move).
Preferably, the cup 12 is directed towards the lower part of the container body.
In an alternative embodiment, the tab of material 27 may be made in a back-standing planar area, as illustrated in FIG. 4, to avoid the protrusion thereof above the plan of the plate 19, or to avoid a too significant protrusion.

In the embodiment shown in FIGS. 6 and 7, the plate 19 includes an orifice 15 adapted to removably receive and hold the functional structural part 12 of the accessory 11.

Herein, the orifice 15 has a circular general shape, adapted to receive the circular cup 12 of the accessory 11. Its handle 13 then extends parallel to the plan of the plate 19, just above the access opening 22 to the packaged product.
If need be, the upper edge of the cup 12 will be equipped with a slight peripheral edge to ensure its correct holding on the edge of the orifice 15.

In FIGS. 6 and 7, the orifice 15 is integrally made within the volume of the plate 19.

FIG. 8 illustrates an alternative embodiment in which the orifice 15 is simply partially made within the volume of the plate 19 and emerges in the internal edge 20 thereof. To ensure the embedding holding of the accessory, the cross-section of the circular orifice 15 is greater than a half-disk.

Here again, if need be, the upper edge of the cup 12 will be equipped with a slight peripheral edge to ensure the correct holding thereof on the edge of the orifice 15.

FIG. 9 is a cross-sectional view that illustrates an embodiment in which the plate 19 is of conventional structure, with a collection/distribution accessory 11 provided with means 28 allowing the releasable fixation thereof to the internal edge 20 of said plate 19.

Herein, the free end of the handle 13 of the accessory 11 (opposed to the cup 12), includes a hanging structure 28 that is in the form of two parallel arms 29 and 30 delimiting between each other an engagement notch 31 (to advantageously ensure an elastic engagement, also called “clipping”).
This engagement notch 31 allows the hanging at will of the accessory 11 to the internal edge 20 of the plate 19, by simple insertion with a slight force, as well as its taking down. It is observed here that this internal edge 20 of the plate 19 includes an end roll 32 on which the engagement notch 31 comes in position.

It will be noted that an identical or similar hanging structure 28 can be provided to ensure the hanging of the accessory 11 at any place of the edge 21 that delimits the access opening 22 to the packaged product.

This embodiment has the interest that it doesn't need the modification of the known lid structures.

As another alternative, the modes of assembly illustrated in FIGS. 6 to 9 may be contemplated with a back-standing planar area, as illustrated in FIG. 4, to avoid the protrusion of the accessory 11 above the plan of the plate 19, and to avoid a too significant protrusion.

In other possible alternatives, several orifices 15 may be provided to allow the hanging of one or several accessories 11.

Moreover, the orifice(s) 15 may be formed at other places, for example in the circular part of the annular flange, or in a tab extending vertically or at an angle, towards the bottom of the container, from the ring 8.

1-16. (canceled)

17. A packaging structure for the storage and the distribution of a bulk product, for example a powder product, which packaging structure (1) includes:
a container (2) in the form of a box, which container (2) includes (i) a metal container body (3) provided with a lower part (4) and an upper part (5), which upper part (5) delimits an upper opening (6), and (ii) a lid structure (7), to seal said upper opening (6),
said lid structure (7) comprising:
(i) a metal mounting ring (8) including—an external part (16) adapted to be fixed on an edge of said container body (3) delimiting said upper opening (6), and—an internal part (17) provided with an annular flange (18), intended to extend at said body opening (6), said internal part (17) including an internal edge (21) delimiting an access opening (22) to the packaged product,
(ii) a sealing member (9) for said access opening (22) to the packaged product, consisting in a peelable membrane (9) hermetically fixed, in a detachable manner, to said annular flange (18), and
(iii) a removable overcap (10), intended to be positioned on the upper edge of the container body (3), above said mounting ring (8) and its associated sealing member (9), to seal said access opening (22) to the packaged product, and
an accessory (11) for the collection and the distribution of a portion of said packaged product,
wherein said packaging structure (1) includes means (14, 15, 28) for making a releasable assembly of said accessory (11) with said metal mounting ring (8).

18. The packaging structure according to claim 17, wherein the annular flange (18) of the mounting ring (8) is continued towards the inside by a plate (19), which plate (19) is in the shape of a disk segment, provided with an internal edge (20) that delimits a part of said access opening (22) to the packaged product, and which plate (19) extends in the plan or substantially in the plan of said annular flange (18).

19. The packaging structure according to claim 17, wherein said accessory (11), for the collection and the distribution of the product, includes a handle (13) at one end of which is arranged a functional structural part (12) for the collection and the distribution of the product.

20. The packaging structure according to claim 19, wherein said accessory (11), for the collection and the distribution of the product, consists in a measuring spoon, provided with a cup-shaped functional structural part (12).

21. The packaging structure according to claim 19, wherein the annular flange (18) of the mounting ring (8) is continued towards the inside by a plate (19), which plate (19) is in the shape of a disk segment, provided with an internal edge (20) that delimits a part of said access opening (22) to the packaged product, and which plate (19) extends in the plan or substantially in the plan of said annular flange (18),
and said releasable assembly means include at least one orifice (15) formed in said mounting ring (8), adapted to receive the functional structural part (12) or the handle (13) of said accessory (11).

22. The packaging structure according to claim 21, wherein said orifice(s) (15) are made in the plate (19) that continues the annular flange (18) of the mounting ring (8).

23. The packaging structure according to claim 22, wherein said accessory (11), for the collection and the distribution of the product, consists in a measuring spoon, provided with a cup-shaped functional structural part (12),
and said plate (19) includes an orifice (15), of closed contour or emerging in its internal edge (20), adapted to receive, by embedding, the cup-shaped functional structural part (12) of said accessory (11).

24. The packaging structure according to claim 22, wherein said accessory (11), for the collection and the distribution of the product, consists in a measuring spoon, provided with a cup-shaped functional structural part (12),
and said plate (19) includes at least one orifice (15) adapted to receive the handle (13) of said accessory (11).

25. The packaging structure according to claim 24, wherein said orifice (15) goes through the plate (19), its axis extending perpendicularly or substantially perpendicularly to the plan of said plate (19).

26. The packaging structure according to claim 24, wherein said orifice (15) is made in or by a cut and/or folded part (27) of said plate (19), in a manner adapted so that its axis extends parallel or substantially parallel to the plan of this plate (19).

27. The packaging structure according to claim 22, wherein said plate (19) includes a back-standing planar area (26) on the side of the lower part (4) of the container body (3) and emerging in the internal edge (20) thereof, back-standing planar area (26) in which are formed said orifice(s) (15).

28. The packaging structure according to claim 17, wherein said accessory (11) includes a hanging structure (14) arranged so as to allow the hanging thereof to at least one orifice (15) formed in said lid structure (7), for the releasable assembly thereof.

29. The packaging structure according to claim 28, wherein the accessory (11), for the collection and the distribution of the product, includes a handle (13) at one end of which is arranged a functional structural part (12) for the collection and the distribution of the product,
and said hanging structure (14) is made at the free end (13′) of the handle (13) of the accessory (11), located opposite its functional structural part (12).

30. The packaging structure according to claim 17, wherein said accessory (11) includes a hanging structure (28) arranged so as to allow the hanging thereof on the internal edge (21) delimiting said access opening (22) to the packaged product.

31. The packaging structure according to claim 30, wherein the annular flange (18) of the mounting ring (8) is continued towards the inside by a plate (19), which plate (19) is in the shape of a disk segment, provided with an internal edge (20) that delimits a part of said access opening (22) to the packaged product, and which plate (19) extends in the plan or substantially in the plan of said annular flange (18),
and said accessory (11) includes a hanging structure (28) arranged so as to allow the hanging thereof to the internal edge (20) of the plate (19) that continues the annular flange (18) of the mounting ring (8).

32. The packaging structure according to claim 30, wherein said hanging structure (28) is in the form of two arms (29, 30) delimiting between each other an engagement notch (31) on said internal edge (21) delimiting said access opening (22) to the packaged product.

33. The packaging structure according to claim 31, wherein said hanging structure (28) is in the form of two arms (29, 30) delimiting between each other an engagement notch (31) on said internal edge (21) delimiting said access opening (22) to the packaged product.
